(19) United States
(12) Patent Application Publication
(10) Pub. No.: US 2006/0012679 A1
(43) Pub. Date: Jan. 19, 2006

(54) Multifunction vehicle interior imaging system

(76) Inventor: Galen E. Ressler, White Lake, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/891,304

(22) Filed: Jul. 14, 2004

(51) Int. Cl. H04N 7/18

(52) U.S. Cl. 348/148

(57) ABSTRACT

Methods and apparatus are provided for monitoring and responding to the activity within a vehicle interior. The apparatus comprises a multifunction processor coupled to imaging devices within the vehicle. The imaging devices view the driver and passenger areas of the vehicle interior, and provide imaging data to the multifunction processor. The processor assesses the images in accordance with pre-existing data, and then takes predetermined responsive courses of action as a result of the assessment. Typical courses of action include alerting a drowsy driver, identifying an unauthorized intruder, adjusting air bag deployment for different-sized passengers, personalizing the vehicle environment for the driver, and transmitting images to a remote location for emergency response or subsequent investigation.

### TECHNICAL FIELD

The present invention generally relates to imaging within a vehicle, and more particularly relates to a multifunction imaging system for the interior of a vehicle.

### BACKGROUND

The ongoing advancement of digital imaging technology has enabled new application areas to be developed, including those related to automotive safety and security. For example, imager surveillance of a vehicle interior can provide information relating to driver/passenger identity and activity, air bag deployment constraints, vehicle condition, and many other types of activities related to the vehicle interior. Digital imaging surveillance can also enable images to be processed, analyzed, responded to, and/or communicated to a remote location.

Automotive applications for interior surveillance can include driver authorization/intruder detection, driver attentiveness monitoring, and driver personalization. Other imaging applications may relate to air bag deployment control, seat belt usage, passenger occupancy status, and so forth. An imaging system can also include an alarm capability, which may be used, for example, to alert a driver to a potentially unsafe situation. Stored images can be recalled to identify vehicle interior conditions before, during, and after an unusual event, providing valuable information to investigators.

Imaging systems for the types of applications previously described generally require significant technical content, in the form of hardware and software. For example, a single-function system would typically include a digital camera, a processor, a communication interface, and perhaps an alarm system and/or other auxiliary devices. To accommodate multiple functions, a number of single-function systems could be considered for installation into a vehicle. Typically, however, the feasibility of installing multiple single-function imaging systems into a production vehicle may be highly constrained due to space and cost considerations.

Accordingly, it is desirable to provide a multifunction imaging system for a vehicle interior that is compatible with the typical space and cost constraints of production vehicles. In addition, it is desirable to provide a multifunction imaging system that is capable of performing a wide range of monitor and control functions. Furthermore, other desirable features and characteristics of the present invention will become apparent from the subsequent detailed description and the appended claims, taken in conjunction with the accompanying drawings and the foregoing technical field and background.

### BRIEF SUMMARY

According to various exemplary embodiments, devices and methods are provided for monitoring and responding to the activity within a vehicle interior. One embodiment comprises a single multifunction imaging system for the interior of a vehicle. In this embodiment, imaging devices are typically mounted within the interior of the vehicle, in order to monitor the driver and passenger areas of the vehicle interior. An electronic control unit is typically installed within the vehicle to communicate with the imaging devices. The imaging devices communicate images of the monitored activity within the vehicle interior to the electronic control unit, and the electronic control unit takes responsive courses of action based on analyses of the monitored activity images.

The imaging devices can typically function in either visible light or in the dark. To function in the dark, an illuminating medium is generally used, such as infrared. A typical illuminating medium can be formed from infrared light emitting diodes, which can provide sufficient illumination for the imagers without being visible to the driver or passengers.

The electronic control unit generally includes a processor configured to receive and analyze the vehicle interior activity images from the imaging devices. The processor typically makes assessments of the driver and passenger characteristics, based on previously stored algorithms and data, and then generates an appropriate predetermined course of action.

Typical predetermined courses of action might include alerting a drowsy driver, identifying an unauthorized intrusion, adjusting air bag deployment for different-sized passengers, personalizing the vehicle environment for the driver, and transmitting images to a remote location for emergency response or subsequent investigation. Due to the exemplary system configuration of a single processor implementing multiple response functions based on received images, the resulting economies of space and cost enhance the feasibility of installing this type of surveillance system into a production vehicle.

### BRIEF DESCRIPTION OF THE DRAWINGS

The present invention will hereinafter be described in conjunction with the following drawing figures, wherein like numerals denote like elements, and

FIG. 1 is a simplified illustration of an exemplary multifunction imaging system for a vehicle interior; and

FIG. 2 is a block diagram of an exemplary multifunction imaging system for a vehicle interior.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention pertain to the area of monitoring the activity in a vehicle interior and responding automatically to the monitored activity in an appropriate manner. In the exemplary embodiment, a single processor typically receives imaging data from multiple imaging devices that cover fields of view encompassing the driver and passenger areas of the vehicle interior. The processor is typically configured to process and analyze the received image data, and to perform multiple responsive functions, based on the data analysis. The responsive functions may include intrusion detection, driver personalization, air bag control, and other responses related to activity occurring in the vehicle interior. The use of a single processor combined with multiple imaging devices results in a multifunction system that is typically compatible with the space and cost constraints of a production vehicle.

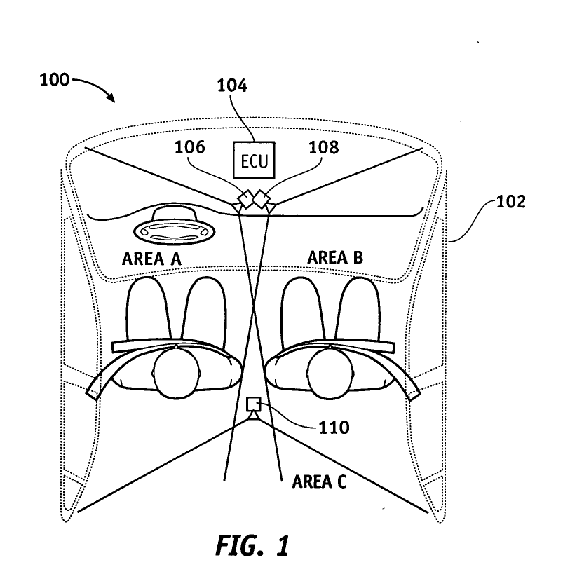

According to an exemplary embodiment of a multifunction imaging system 100 for a vehicle interior 102, as illustrated in FIG. 1, an electronic control unit (ECU) 104 is coupled to imagers 106, 108, 110. The interface couplings are not shown in FIG. 1 for clarity. Imager 106 is typically positioned to view the driver area A of the vehicle interior, while imager 108 is typically positioned to view the front seat passenger area B, and imager 110 is typically positioned to view the rear seat passenger area C. Additional imagers could also be included in the exemplary system to view other parts of the interior as appropriate.

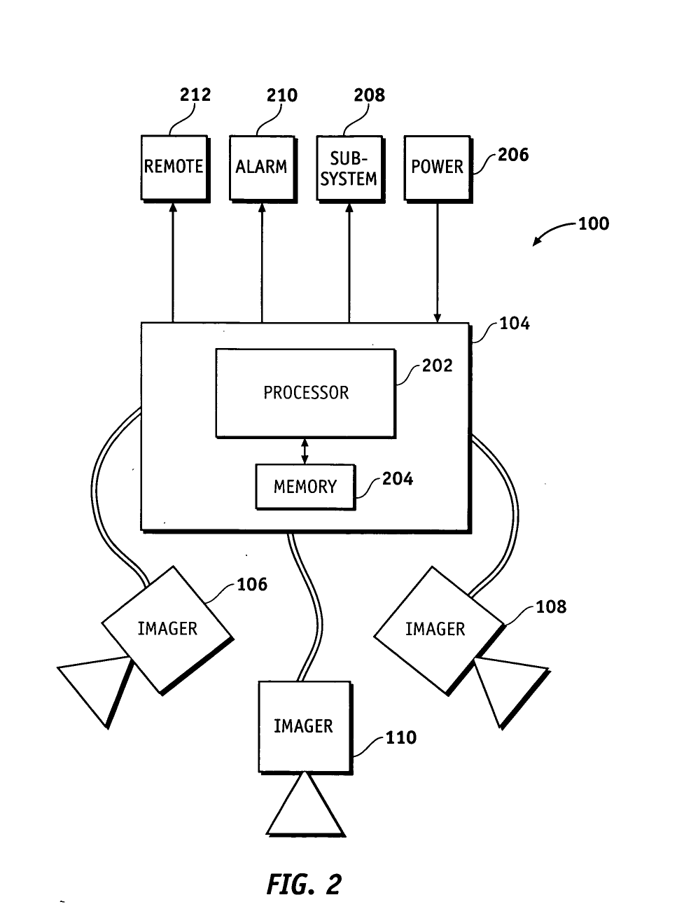

A more detailed block diagram of system 100 is shown in FIG. 2. In this embodiment, ECU 104 includes a processor 202 and a memory 204, in addition to other circuitry (not shown), such as communication, power supplies, etc. Processor 202 typically communicates with imagers 106, 108, 110, and also with memory 204 via any appropriate interface, such as Low Voltage Differential Signal (LVDS). ECU 104 generally receives power from a battery 206, which is typically the main vehicle battery. Alternately, ECU can be powered by any other appropriate power source within the vehicle. Imagers 106, 108, 110 typically receive power from ECU 104.

Processor 202 typically provides output signals to various functional devices, such as an automotive sub-system 208 or an alarm device 210. These output signals can be provided directly from ECU 104 (as shown in FIG. 2), or can be provided via a single output from ECU 104 to a serial data bus that can communicate with multiple functional devices. In addition, processor 202 can generally transmit imaging data to a remote facility 212, such as an emergency call center, or to other types of monitoring systems.

Imagers 106, 108, 110 are typically digital camera devices, although other equivalent devices may be used as well. Imagers 106, 108, 110 are generally configured to capture, store and/or transfer two-dimensional or three-dimensional images in their respective fields of view (A, B, C). In this exemplary embodiment, such images are typically transferred to processor 202, where they can be analyzed and/or stored in memory 204. Imagers 106, 108, 110 can typically operate in visible light, and can also function in the dark with the aid of infrared or other appropriate illumination. Infrared illumination would typically be in the form of a cluster of light emitting diodes (LED's) located adjacent to their respective imagers (not shown in FIG. 2).

According to exemplary embodiments of the present invention, processor 202 can provide multiple functions that are responsive to the analysis of incoming images from imagers 106, 108, 110. Typical examples of functional responses are driver personalization, event recorder, air bag suppression/modulation, and security function. It will be appreciated that many other types of functional responses can also be implemented within the same exemplary embodiment, such as intrusion detection, alerting a drowsy driver with an alarm signal, monitoring driver and passenger seat belt usage, and many other aspects of vehicle interior surveillance and response. The typical examples of processor 202 functional responses initially listed above can be more fully described as follows:

a) Driver Personalization

The exemplary system would typically recognize the driver in accordance with previously stored facial characteristics. Processor 202 would then typically transmit personalization commands to appropriate sub-systems 208, based on options previously selected by the driver. For example, the driver seat could be adjusted to a memory position automatically, without the need for manual activation, as is typically the case in current automobile production. Other personalization actions might include pedal and mirror adjustments, climate control, entertainment system settings, and so forth.

b) Event Recorder

Image data can be recorded on the basis of specified trigger criteria. Typical examples of specified trigger criteria can include vehicle intrusion (see paragraph d, below), unusual vehicle maneuvers, vehicle collision, a driver-selected event, or any other type of activity of interest. Such triggered images can be used, for example, to transmit an emergency signal to a call center, or for subsequent analysis.

c) Air Bag Suppression/Modulation

Air bag deployment can be totally suppressed or modulated (adjusted) in compliance with Federal Motor Vehicle Safety Standard 208, based on the viewed images of passengers in the vehicle interior. Imager 108, for example, can provide images of the front seat passenger to processor 202 for analysis, with respect to the size and position of the passenger. As a result of this analysis, processor 202 can command an appropriate sub-system 208 to suppress and/or modulate air bag deployment corresponding to the size and position of the passenger. For example, if a very small child or an “out of position” occupant (i.e., an occupant too close to an air bag) is viewed by an imager, processor 202 would typically signal the suppression of a potential air bag deployment. Alternately, processor 202 might signal a modulated air bag deployment for a relatively small-sized passenger.

d) Security Function

An exemplary embodiment of a multifunction imaging system can include a subscription function to enroll all authorized drivers of a vehicle. The exemplary system can be configured to store multiple images of an authorized driver in order to subscribe that individual as an authorized driver into the system memory. If an unauthorized person attempted to drive the vehicle, the exemplary system could disable the ignition, for example, and/or activate an alarm.

Accordingly, the shortcomings of the prior art have been overcome by providing an improved imaging system for a vehicle interior. In the exemplary embodiment described herein, a single, multifunction processor 202 and associated memory 204 are typically configured within a vehicle ECU to receive images received from multiple imagers (106, 108, 110) having fields of view that typically encompass the driver and passenger areas of the vehicle interior. Processor 202 is typically configured to analyze and respond to the received images in accordance with various pre-programmed options, such as driver personalization, air bag control, intrusion detection, and the like. The use of a single, multifunction processor communicating with multiple imagers enables the exemplary system to be compatible with the space and cost limitations of a production vehicle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A multifunction imaging system for the interior of a vehicle, comprising:
a plurality of imaging devices mounted within the interior of the vehicle, the plurality of imaging devices configured to monitor activity within the vehicle interior; and
an electronic control unit installed within the vehicle, the electronic control unit configured to communicate with the plurality of imaging devices;
wherein the plurality of imaging devices communicate images of the monitored activity within the vehicle interior to the electronic control unit, and wherein the electronic control unit is configured to take responsive courses of action based on analyses of the monitored activity images.

2. The multifunction imaging system of claim 1 wherein at least one of the plurality of imaging devices monitors the activity in the driver area of the vehicle interior.

3. The multifunction imaging system of claim 1 wherein at least one of the plurality of imaging devices monitors the activity in the front seat passenger area of the vehicle interior.

4. The multifunction imaging system of claim 1 wherein at least one of the plurality of imaging devices monitors the activity in the rear seat passenger area of the vehicle interior.

5. The multifunction imaging system of claim 1 wherein the imaging devices;
function in visible light.

6. The multifunction imaging system of claim 1 wherein the imaging devices function with infrared illumination.

7. The multifunction imaging system of claim 1 wherein the electronic control unit comprises a processor configured to process and analyze the monitored activity images received from the plurality of imaging devices.

8. The multifunction imaging system of claim 7 wherein the processor makes an assessment of the characteristics of a driver of the vehicle, based on the analysis of the monitored activity images in the vehicle interior.

9. The multifunction imaging system of claim 8 wherein the processor initiates a predetermined responsive course of action based on the assessment of the driver characteristics.

10. The multifunction imaging system of claim 7 wherein the processor makes an assessment of the characteristics of passengers in the vehicle, based on the analysis of the monitored activity images in the vehicle interior.

11. The multifunction imaging system of claim 10 wherein the processor initiates a predetermined responsive course of action based on the assessment of the passenger characteristics.

12. The multifunction imaging system of claim 7 wherein the processor makes an assessment of the characteristics of the vehicle interior, based on the analysis of the monitored activity images in the vehicle interior.

13. The multifunction imaging system of claim 12 wherein the processor initiates a predetermined responsive course of action based on the assessment of the vehicle interior.

14. A method of monitoring activity within the interior of a vehicle, comprising the steps of:
generating images of activity within the interior area of the vehicle;
analyzing the generated images to assess the activity within the interior area of the vehicle; and
initiating one or more predetermined courses of action based on the assessment of the activity within the interior area of the vehicle;
wherein the generated images are analyzed by a single processor.

15. The method of claim 14 wherein the images are generated by imagers located within the interior of the vehicle.

16. The method of claim 14 wherein the single processor is located within the vehicle.

17. The method of claim 14 wherein the activity in the interior area of the vehicle comprises the characteristics of a driver of the vehicle.

18. The method of claim 14 wherein the activity in the interior area of the vehicle comprises the characteristics of passengers in the vehicle.

19. The method of claim 14 wherein the activity in the interior area of the vehicle comprises the physical condition of the vehicle interior.

20. The method of claim 14 wherein the one or more predetermined courses of action comprise activating an alarm to warn of a potentially unsafe condition.

21. The method of claim 14 wherein the one or more predetermined courses of action comprise modifying a sub-system within the vehicle.

22. The method of claim 21 wherein an air bag sub-system is suppressed.

23. The method of claim 21 wherein an air bag sub-system is modulated.

24. The method of claim 14 wherein the one or more predetermined courses of action comprise implementing a vehicle control function in response to a physical action of the driver.

25. The method of claim 14 wherein the one or more predetermined courses of action comprise authorizing a driver of the vehicle.

26. The method of claim 14 wherein the one or more predetermined courses of action comprise recording an event based on trigger criteria.

27. The method of claim 26 wherein the recorded event is transmitted to a remote location via telematics.
